(19) United States
(12) Patent Application Publication
(10) Pub. No.: US 2016/0081042 A1
(43) Pub. Date: Mar. 17, 2016

(54) Communication Efficiency

(71) Applicant: Nokia Corporation, Espoo (FI)

(72) Inventors: Sayantan Choudhury, Berkeley, CA (US); Esa Juhani Tuomaala, El Cerrito, CA (US); Klaus Doppler, Albany, CA (US); Fabiano de Sousa Chaves, Manaus AM (BR); Faud Mousse Abinader, JR., Manaus-AM (BR); Andre Mendes Cavalcante, Manaus AM (BR); Erika Portela Lopes de Almeida, Brasilia - DF (BR)

(21) Appl. No.: 14/484,468

(22) Filed: Sep. 12, 2014

(51) Int. Cl. H04W 52/30; H04W 24/10; H04W 24/02

(52) U.S. Cl. CPC H04W 52/30; H04W 24/02; H04W 24/10

(57) ABSTRACT

There is provided a method, including receiving, by a receive node, a transmission request message for data transmission from a transmit node of a first basic service set, wherein the transmission request message includes an indication of a modulation and coding scheme to-be-used in the data transmission; detecting signal strength of the transmission request message; determining, based on the signal strength and the indicated modulation and coding scheme, a maximum tolerable interference level during the data transmission; and in response to the transmission request message, generating and sending, to the transmit node, a transmission permission message including an indication of the maximum tolerable interference level.

### FIELD OF THE INVENTION

The invention relates generally to wireless communication.

### BACKGROUND

With a dense deployment of user devices, it may happen that multiple user devices may access the network simultaneously which may lead to collisions or otherwise degrade communication efficiency.

### BRIEF DESCRIPTION OF THE INVENTION

Some aspects of the invention are defined by the independent claims.

According to an aspect of the invention, there is provided a computer program product embodied on a distribution medium readable by a computer and comprising program instructions which, when loaded into an apparatus, execute the method according to any of the appended claims.

According to an aspect of the invention, there is provided a comput-er program product readable by a computer and comprising program instructions which, when loaded into an apparatus, execute the method according to any of the appended claims.

According to an aspect of the invention, there is provided an apparatus comprising means for performing any of the embodiments as described in the appended claims.

According to an aspect of the invention, there is provided a method, comprising: generating, by a transmit node, a transmission request message in order to request for data transmission permission from a receive. node; including an indication of a modulation and coding scheme to-be-used in the data transmission in the transmission request message; sending the transmission request message to the receive node; and causing a reception of a transmission permission message from the receive node indicating whether or not the transmit node is allowed to perform the data transmission.

According to an aspect of the invention, there is provided an apparatus, comprising: at least one processor and at least one memory including a computer program code, wherein the at least one memory and the computer program code are configured, with the at least one processor, to cause a transmit node to perform operations comprising: generating a transmission request message in order to request for data transmission permission from a receive node; including an indication of a modulation and coding scheme to-be-used in the data transmission in the transmission request message; sending the transmission request message to the receive node; and causing a reception of a transmission permission message from the receive node indicating whether or not the transmit node is allowed to perform the data transmission.

Some embodiments of the invention are defined in the dependent claims.

### LIST OF THE DRAWINGS

In the following, the invention will be described in greater detail with reference to the embodiments and the accompanying drawings, in which

FIG. 1 presents a network according to an embodiment;

FIGS. 2 to 5 and 7 show methods according to some embodiments;

FIGS. 6A and 6B show example frame structures;

FIG. 8 depicts an example of an unbalanced transmit power scenario; and

FIGS. 9 to 11 illustrate apparatus according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

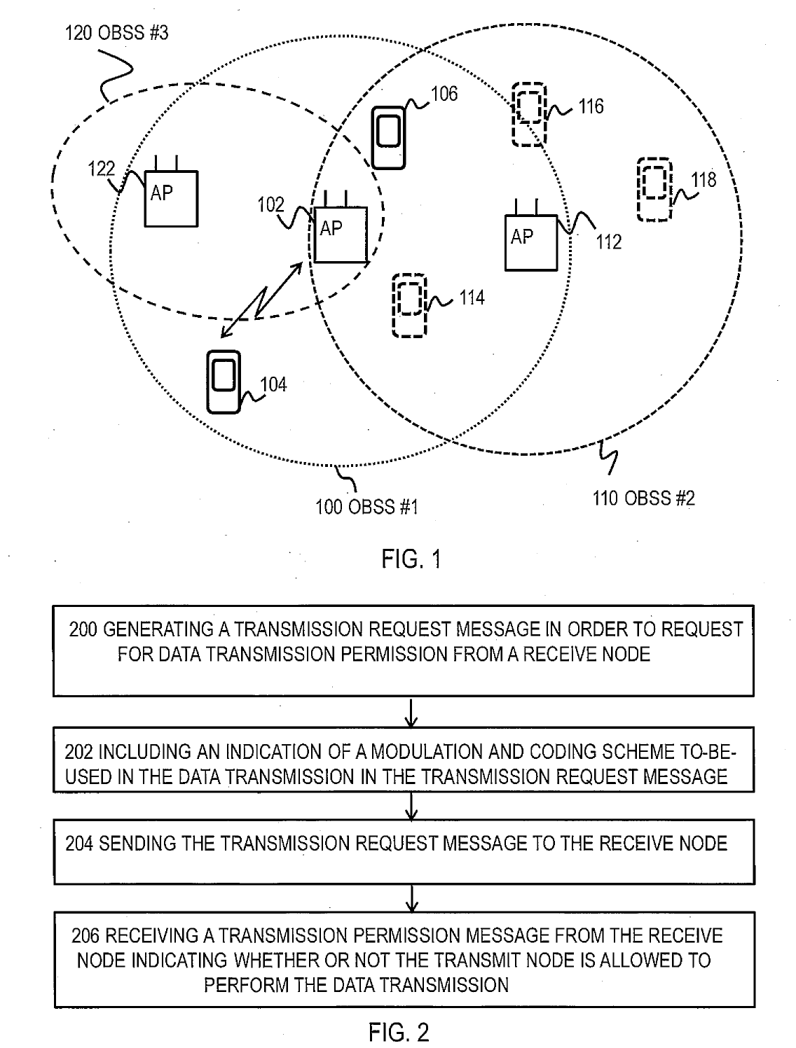

The IEEE 802.11 standard for Wireless Local Area Networks (WLANs), known as Wi-Fi, has been broadly adopted to provide wireless broadband access to Internet. With the increase on the demand for wireless Internet access, dense Wi-Fi deployments become more common. In a dense Wi-Fi deployment, a high density of Wi-Fi terminals and networks operate without coordination and with overlapping coverages. An IEEE 802.11-enabled station (STA), such as user terminal/equipment 104 or 106 in FIG. 1, may associate and communicate with an access node/point (AP) 102. The AP 102 bridges a Basic Subscriber Set (BSS) 100 of STAs 104, 106 to the network. The STA 104,106 may comprise a mobile phone, a palm computer, a wrist computer, a laptop, a personal computer, or any device capable to access the wireless radio access network, such as the WLAN. The access node 102 may be a WLAN (IEEE 802.11) access point (e.g. Wi-Fi base station), for example.

Although the description is written from the point of view of the WLAN, the proposed solution is applicable to other technologies as well. For example, the proposed features. may be applicable to cellular device-to-device (D2D) or machine-to-machine (M2M) connections. However, for the sake of simplicity, WLAN is considered in the description.

With a dense deployment of STA and access points APs, it may happen that multiple STAs may access the network simultaneously which may lead to collisions. As one example, Carrier Sensing Multiple Access with Collision Avoidance (CSMA/CA) is proposed as means to tackle these collisions. With the CSMA/CA, a node (e.g. a STA) listens to the channel prior to transmitting in a procedure known as a Clear Channel Assessment (CCA). In case the node detects an ongoing transmission on the channel during the CCA, the node may defer the transmission for a random time. In this manner, collisions may be reduced. On the other hand, this solution may prevent the node from using the channel at all for that period of time. Such a situation may become even more frequent in deployments of overlapping basic service sets (OBSSs), where the STA may need to contend for the channel access also with the nodes of the other, overlapping BSS. Due to high number of communication nodes contending for the channel access, collision probability increases and back-off times may become longer. This may degrade the communication performance in terms of throughput, latency and user quality-of-service (QoS).

In FIG. 1, there are three different BSSs, 100, 110 and 120. In the BSS 100, there are at least the AP 102 and the STAs 104 and 106. In the BSS 120, there are at least an AP 112 and STAs 114, 116 and 118. In the BSS 120, there is at least an AP 122. These BSSs 100, 110, and 120 may at least partly overlap with each other. For example, the AP 102 may be located in a coverage area of also the other two BSSs 110 and 120.

There may be different types of problems associated with such an overlapping scenario. For example, let us consider that transmit powers of the APs 102 and 112 are 30 dBm, whereas the STAs operate with a lower transmit power of 15 dBm. Spatial distribution is such that the APs 102, 122 hear each other. Let us ignore the BSS 120 in this example scenario.

As one problem, called an exposed node-problem, let us consider that the STA 106 transmits an UL transmission to the AP 102. The path loss between the STA 106 and the AP 102 is assumed to be 40 dBm and the path loss between the AP 102 and the AP 112 is 90 dBm. Then, the received power of the UL transmission from the STA 106 at the AP 102 is −25 dBm(=15 dBm−40 dBm). For such a high received power from the STA 106, the interference of −60 dBm (=30 dBm−90 dBm) from the other AP's 112 simultaneous transmission may not be harmful. This may be because the Signal-to-Interference-plus-Noise Ratio (SINR) would still be 35 dB (=−25 dBm+(−60 dBm)). Nevertheless, in case the AP 112 of the second BSS 110 hears the UL transmission from the STA 106 in the first BSS 100, the AP 112 may decide not to reuse the channel. Therefore, this opportunity of channel reuse may be unnecessarily lost.

As another problem, called a hidden node problem, which may exist in the OBSS scenario, let us assume an UL transmission from the STA 104 to the AP 102. Let us further assume that the path loss between the STA 104 and the AP 102 is 70 dBm, whereas the path loss between the APs 102, 112 remains in 90 dBm. In such case, the received power at the AP 102 is −55 dBm (=15 dBm−70 dBm). For such a low received power, the interference of −60 dBm (=30 dBm−90 dBm) from the other AP's 112 simultaneous transmission may be harmful. This is because the SINR would be only 5 dB (=−55 dBm−(−60 dBm)). In case the AP 112 does not hear the UL transmission from the STA 104, the AP 112 may decide to reuse the channel. This may cause the AP 102 to miss the UL transmission from the STA 104 due to the interference from the AP 112.

Although the source of interference in the examples. is depicted to be the access point/node 112, replacing the AP 112 with a non-AP STA, such as the STA 114, for example, may cause the same problems. Typically, request-to-send (RTS) and clear-to-send (CTS)-messages/frames may be used to tackle the hidden node problem, but their use may be restrictive and may amplify the exposed node problem. That is, they may be used to protect transmissions against collisions, but they are not able to allow and coordinate channel reuse, e.g. simultaneous transmissions from different, overlapping BSSs. It may be noted also that intra-BSS solutions, such as Point Coordination Function (PCF), Hybrid Controlled Channel Access (HOCA) and Power-Save Multi-Poll (PSMP), used to tackle the efficiency degradation problems, are not applicable for the OBSS scenario.

Therefore, a need exists to provide a decentralized (i.e. autonomous) solution for improving the communication efficiency by means of e.g. channel reuse in such an OBSS scenario. This may comprise protecting the current transmission in one BSS while at the same time enabling simultaneous transmissions from an AP or from a STA in a different BSS on a same frequency band. The proposed solution may solve both of the above mentioned problems by managing the coordination of OBSS transmissions.

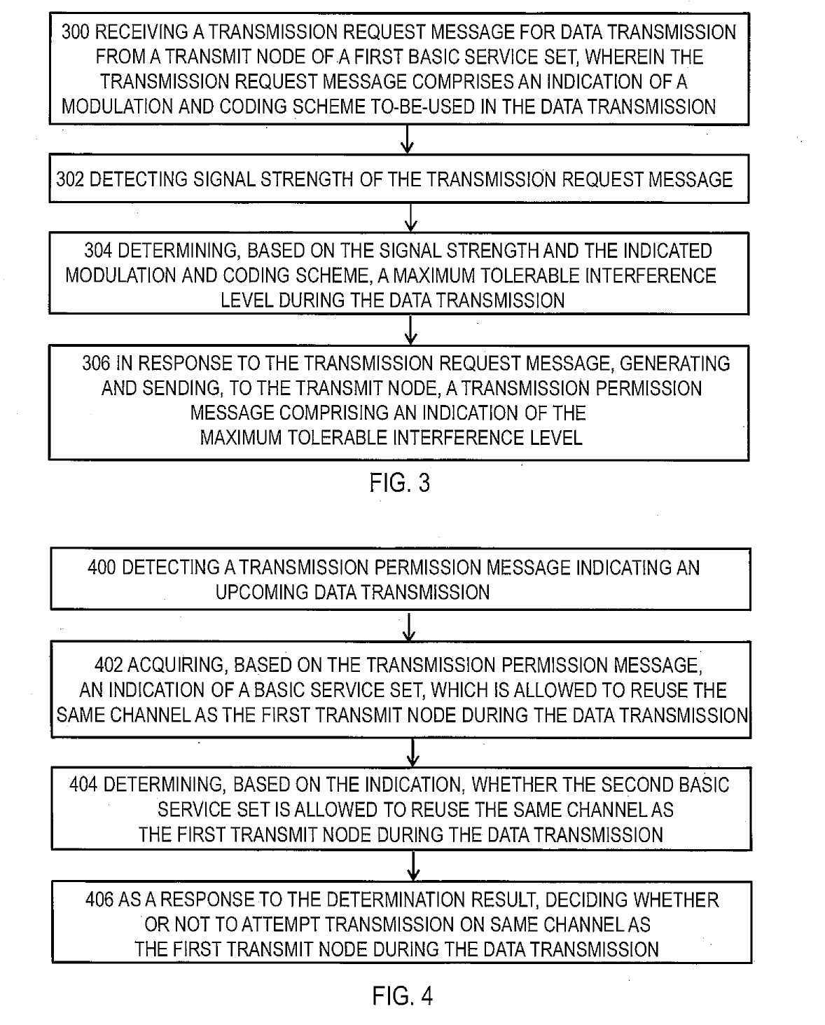

FIG. 2 depicts a method according to the proposal which may be performed by a radio device of a first BSS 100, such as the STA 104. FIG. 3 depicts a method according to the proposal which may be performed by an access point of a first BSS 100, such as the AP 102. FIG. 4 depicts a method according to the proposal which may be performed by a transmit node of an overlapping, second BSS 110 or 120, such as the AP 112 or the STA 114, for example. FIG. 5 depicts a signalling flow diagram between the STA 104 of the first BSS 100, the AP 102 of the first BSS 100, and a potential transmit node of the second BSS 110. Some of the steps in FIG. 5 may overlap with the steps of FIGS. 2 to 4.

In steps 200 and 500, the STA 104 as a first transmit node, may generate a transmission request message in order to request for data transmission permission from the STA 104 to the AP 102. That is, before the STA 104 may start the data transmission, the STA 104 may need to request permission from the intended receiver node, i.e. from the AP 102.

According to an embodiment, the STA 104 may in step 202 include an indication of the to-be-used modulation and coding scheme (MCS) in the transmission request message. That is, the transmission request message may then comprise an indication of the MCS to-be-used in the up-coming data transmission from the STA 104 to the AP 102. In an embodiment, there may be predefined set of MCSs out of which one may be pre-selected for the data transmission and indicated to the receiver node (e.g. the AP 102) in the transmission request message. It may be noted that although the MCS used in transmission of the transmission request message may be the same that will be used in the up-coming data transmission, in an embodiment, the MCS to-be-used in the data transmission is different than the MCS used in the transmission request message. This may be because the transmission request messages are used to protect data transmission and thus they may be sent with a more robust MCS than the following data transmission. Therefore, the MCS of the transmission request message may be more robust than the MCS of the data transmission. For example, the MCS of the transmission request message may be binary phase shift keying (BPSK) with a code rate of 1/2, whereas the MCS of the data transmission may be a 64 quadrature amplitude modulation (64-QAM), with a code rate of 5. By including information about the actual MCS that will be used in the data transmission, a more accurate and reliable estimation of a tolerable interference level at the receiver node may be determined, as will be explained later.

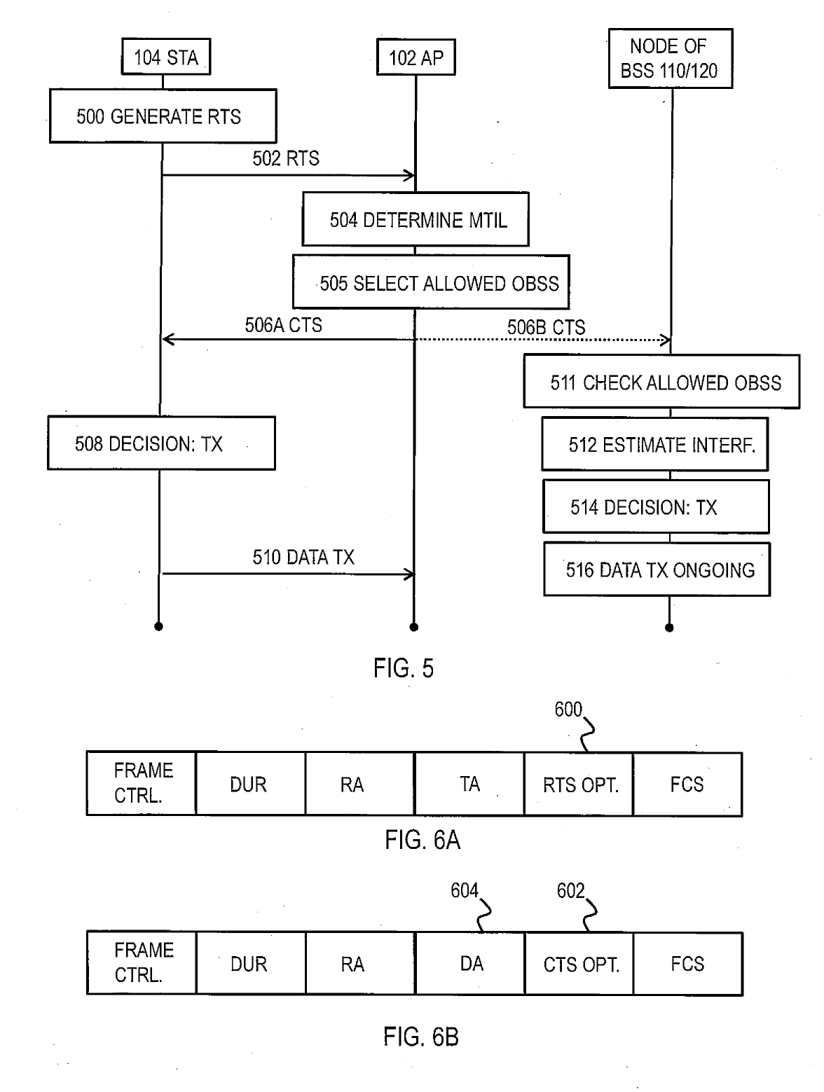

In an embodiment, the transmission request message is a request-to-send-message (RTS). FIG. 6A shows an example of the transmission request message, such as of the RTS message. The proposed modified RTS frame/message may comprise a number of fields. These fields may comprise a FRAME CONTROL-field, a DURATION-field according to which the receivers (except the intended receiver identified in an RA-field) are to set their NAV (Network Allocation Vector) to the start of the data transmission, the RA-field indicating the receiver address of the station that shall receive the frame (i.e. the AP 102), a TA-field indicating the address of the station which has transmitted frame (i.e. the STA 104), and a Frame Check Sequence (FCS)-field. According to an embodiment, the transmission request message may further comprise a field 600 for indicating the MCS of the up-coming data transmission associated with the transmission request message. In an embodiment, this field 600 has one octet to indicate the MCS that will be used in the data transmission. One possible implementation is to use five to seven bits for indicating the MCS, while the remaining bits may be reserved for other purposes. The MCS may be indicated with a predetermined mapping between bits and different MCS options, for example.

In steps 204 and 502, the STA 104 may, after gaining access to the channel, transmit the transmission request message to the AP 102 (or to any intended receiver node of the data transmission). It may be noted that the receiver node could be some other node than the AP 102, such as a non-AP STA. The transmit node 104 could, as well, be an AP instead of the non-AP STA 104. Any combinations are possible, such as transmissions from STA to AP, from AP to STA, from AP to AP, and from STA to STA. However, let us here consider that the receiver node is the AP 102 and the transmit node is the STA 104.

Thereafter, the AP 102 may, in steps 300 and 502, receive from the STA 104 the transmission request message including the indication of the MCS to-be-used in the data transmission.

In step 302, the AP 102 may further detect the signal strength of the transmission request message. The signal strength may be the received signal power of the transmission request message.

Based on the signal strength and the indicated MCS, the AP 102 may in steps 304 and 504 determine a maximum tolerable interference level (MTIL) during the up-coming data transmission. in other words, by knowing how strong the signal from the STA 104 is when the signal is received at the AP 102 (as known, path loss between the STA 104 and the AP 102 may degrease the signal strength), and by knowing the to-be-used MCS, the AP 102 may calculate how much interference is allowed. This determined MTIL may imply how much interference may be caused without the data transmission from the STA 104 being jeopardized. If there is too much interference, then the AP 102 is not able to decode the data transmission from the STA 104 properly and the data may be lost. The determined MTIL may be based on a predefined criterion, such as a minimum SINR required for the indicated MCS. It may be noted that the MTIL may vary significantly based on the to-be-applied MCS of the data transmission. For example, the MTIL during a BPSK modulation may be higher than during a 64-QAM modulation. Therefore, it is important to know which MCS will be used during the actual data transmission form the STA 104 to the AP 102.

In steps 306 and 506A, the AP 102 may, in response to the transmission request message, generate and send a transmission permission message comprising an indication of the maximum tolerable interference level. This message may be targeted to the STA 104, i.e. to the node whose address is indicated in the TA-field of the RTS frame of FIG. 6A.

In an embodiment, the transmission permission message is a clear-to-send (CTS)-message/frame. FIG. 6B shows an example of the transmission permission message, such as of the CTS message. The proposed modified CTS frame/message may comprise a number of fields. These fields may comprise a FRAME CONTROL-field, a DURATION-field according to which the receivers (except the intended receiver identified in an RA-field) are to set their NAV (Network Allocation Vector) to the complete data transmission duration, the RA-field indicating the receiver address of the station that shall receive the frame (i.e. the STA 104), and a Frame Check Sequence (FCS)-field.

In an embodiment, the AP 102 may include an indication of the determined MTIL in the transmission permission message. This information element may be included in a field 602, for example. In an embodiment, this field 602 has one octet to indicate the MTIL. One possible implementation is to use five to seven bits for indicating the MTIL, while the remaining bits may be reserved for other purposes. The MTIL may be indicated in dBm values, for example.

In steps 206 and 506A, the STA 104 may receive the transmission permission message from the AP 102 indicating whether or not the STA 104 is allowed to perform the data transmission with the AP 102. As a result, the STA 104 may in step 508 decide to either start the data transmission or defer the data transmission. Let us assume here that the data transmission takes place in step 510 of FIG. 5. In an embodiment, as the reverse link transmissions may not be protected, acknowledgements (ACK) from the AP 102 to the STA 104 may be postponed to the next transmission time window.

In an embodiment, it may be beneficial to limit the number of possible simultaneous channel re-users. This may take place so that the AP 102 further determines in step 505 which overlapping BSS is allowed to reuse the same channel as the STA 104 during the data transmission from the STA 104 to the AP 102 in the first BSS 100. It may be noted that there may be several different overlapping BSSs detected by the AP 102, such as the BSSs 110 and 120 of FIG. 1. The selection of the overlapping BSS may be based on different considerations, such as interference measurements from different BSSs or pre-negotiation (e.g. by frame exchange), etc.

Then, the AP 102 may include, to the transmission permission message, an indication of the determined overlapping BSS, which is allowed to reuse the same channel as the STA 104 during the data transmission from the STA 104 to the AP 102. In an embodiment as shown in FIG. 6B, the transmission permission message (e.g. the CTS frame) may further carry a DA-field 604 indicating the other BSS 110 allowed to reuse the same channel during the data transmission. The indication may be an address of the second BSS 110, for example. In an embodiment, only one OBSS is indicated. In an embodiment, the DA field 604 may have a length of one octet and at least some of the bits may be used for indicating the OBSS, while possibly remaining bits may be reserved for other purposes.

In an embodiment, multiple OBSSs are indicated in the transmission permission message. In an embodiment, multiple MTI Ls are indicated in the transmission permission message, one MTIL for each of the indicated OBSSs. In an embodiment, a plurality of OBSSs and only one MTIL is indicated. In this case, the receiving OBSS node may need to determine how much interference it can cause on the basis of the indicated plurality of OBSSs and one MTIL. For example, the MTIL may be assumed to aggregate evenly from each of the indicated OBSSs. In case there are four indicated OBSSs, then one OBSS may cause one fourth of the indicated MTIL.

Thereafter, as shown in FIGS. 4 and 5, a potential channel re-user node of another BSS (e.g. the AP 112 or the STA 114 of the BSS 110, or the AP 122 of the BSS 120) may, in steps 400 and 506B, detect and receive the transmission permission message transmitted by the AP 102 of the first BSS 100, wherein the message indicates an upcoming data transmission from the STA 104 to the AP 102.

In steps 402, the AP 112 may acquire, based on the transmission permission message, an indication of a BSS, which is allowed to reuse the same channel as the STA 104 during the data transmission. In step 404 and 511, the AP 112 may then determine, based on the indication, whether the basic service set 110 of the AP 112 is allowed to reuse the same channel. The AP 112 may know the address of its BSS and by checking the indicated address of the DA field 604, the AP 112 may know is it allowed to re-use the channel. In step 406 and 514, the AP 112 may as a response to the determination result of step 404, decide whether or not to attempt transmission on same channel as the STA 104 during the data transmission. In case the BSS 110 is identified as the allowed OBSS, e.g., in the DA-field 604 of the CTS-frame, then the AP 112, belonging to the OBSS 110, may possibly start the simultaneous data transmission, as shown in step 516 of FIG. 5. The transmission of step 516 may take place between the AP 112 and another node of the BSS 110, for example. However, in case the BSS 110 is not identified as a BSS which is allowed to perform the overlapping channel re-use, then the AP 112 may not perform the data transmission of step 516. In this way, by informing in the transmission permission message the OBSS which is allowed to reuse the channel, the AP 102 may avoid that more than one BSS reuses the channel simultaneously and causes an aggregate interference above the MTIL.

In one embodiment, the detected message (e.g. the CTS message of FIG. 6B) may further, as said, comprise an indication of the MTIL allowed at the AP 102 during the upcoming data transmission from the STA 104 of the first BSS 100. The first BSS 100 and the BSS 110/120 may at least partly overlap. As shown in FIGS. 5 and 7, the AP 112 may in steps 512 and 700, estimate the interference/that a transmission from the AP 112 would cause to the AP 102. This step may comprise determining the path loss PL from the AP 112 to the AP 102. Path loss PL may define how much the signal strength degrades during the propagation of the signal from a transmitter to a receiver. As the propagation channel is considered reciprocal, the PL is the same for both directions in a given channel. The path loss PL between the AP 112 and the AP 1.02 may be determined by knowing the distance between the two entities and the applied frequency of the used communication channel. This distance information may be pre-stored in the AP 112 based on network deployment information or it may be obtained from the network, for example. By knowing the path loss PL, the interference/caused to the AP 102 may be defined as the transmit power P_{TX}^{AP112} of the AP 112 minus the path loss PL, that is I=P_{TX}^{AP112}−PL. Fast fading may be neglected as its effect to the received signal strength is significantly less than the effect of the path loss PL.

In one embodiment, the transmit powers of the APs 102 and 112 are the same. In this embodiment, the AP 112 knows the transmit power P_{TX}^{AP102} of the AP 102 by default (a priori). The AP 112 may further detect the signal strength P_{RX}^{AP112} of the received transmission permission message at the AP 112. Based on the detected signal strength P_{RX}¹¹², the AP 112 may determine the path loss PL between the AP 102 and the AP 112. This may be estimated as PL=P_{TX}^{AP112}−P_{RX}^{AP112}. Now the path loss PL is more reliably known than only on the basis of the distance. Thereafter, the AP 112 may, in step 700, estimate the interference I the AP's 112 transmission would cause to the AP 102 on the basis of the determined path loss PL, as I=P_{TX}^{AP112}−PL.

In one embodiment, in case both elements (AP 102 and AP 112) have the same transmit power, then an assumption that the interference caused by the AP 112 to the AP 102 is equal to the interference that the AP 112 suffers from the AP 102 may be valid. The interference caused by the AP 102 may be measured from the received CTS frame, for example.

However, in one embodiment, transmit powers vary between different entities and the transmit power of the AP 102 is unknown. For example, there may be different downlink (DL) and UL transmit powers. In order to cope with such scenarios of unknown transmit powers, the AP 102 may, in an embodiment, include an indication of the transmit power P_{TX}^{AP102} of the AP 102 in the transmission permission message (e.g. in the CTS frame). As said, when the transmit powers are unbalanced, the AP 112 may not know the P_{TX} of the transmitter of the transmission permission message by default (a priori).

Thus, it may be beneficial for the AP 102 to transmit an indication of its transmit power P_{Tx}^{AP102} in the CTS frame so that the receivers of the CTS frame may detect what the transmit power of the AP 102 actually is.

In an embodiment, the transmission permission message (e.g. the CTS frame) may thus further carry an indication of the transmit power P_{TX}^{AP102} of the AP 102 (i.e. the transmitter of the CTS frame). In an embodiment, this may be indicated in the field 602 of the CTS frame. In this embodiment, the field 602 may have two octets, one for indicating the MTIL and one for indicating the transmit power P_{TX}^{AP102}. One possible implementation is to use five to seven bits for indicating the each of these information elements, while the remaining bits of the options-field may be reserved for other purposes.

This embodiment where the AP 102 further indicates the P_{TX}^{AP102} makes the interference I estimation even more reliable as the AP 112 may take the indicated transmit power P _{TX}^{AP102} into account when determining the path loss PL between the AP 102 and the AP 112. The AP 112 may then determine, in step 700, the path loss PL as PL=P_{TX}^{AP112}−P_{RX}^{AP112} and the interference I the AP 112 would cause to the AP 102 as I=P_{TX}^{AP112}−PL.

Thereafter, in step 702, the AP 112 may compare the estimated interference/to the indicated maximum tolerable interference level. As a response to the comparison result, the AP 112 may, in steps 704 and 514, take the comparison result further into account when determining whether or not to attempt transmission on the same channel as the STA 104 during the data transmission from the STA 104 to the AP 102. In case the AP's 112 transmission would cause interference below the indicated MTIL, the AP 112 may reset its NAV to zero and resume the conventional contention for the channel access in order to possibly transmit, in step 516, during the data transmission from the STA 104 to the AP 102 (i.e. simultaneously with the data transmission 510). In this way non-harmful simultaneous OBSS transmissions may be beneficially coordinated in a decentralized way, which may improve channel spatial reuse and communication efficiency. However, in case the AP 112 would cause interference above the indicated MTIL, then the AP 112 may decide to not transmit simultaneously with the STA 104. In this case the AP 112 may keep the set NAV value and may not transmit until the end of the data transmission 510.

In an embodiment, the indication of the allowed BSS may have higher priority than the estimated interference caused to the AP 102. That is, the AP 112 of the OBSS 110 first checks the indication of the allowed BSSs in step 404/511 and only if the AP 112 is allowed to start the simultaneous data transmission, the AP 112 continues to perform the steps of FIG. 7. In one embodiment, even if the estimated interference is below the indicated MTIL, the AP 112 may not start the transmission in step 516 in case nodes of this BSS are not allowed to transmit.

As described, the proposed mechanism may be based on the exchange of modified RTS/CTS control frames between the STA 104 (as a data transmit node) and the AP 102 (as a data receiver node) in order to protect the UL transmission from the STA 104 to the AP 102 from collisions, and to provide the maximum tolerable interference level information to potential channel re-users of other BSSs (a second transmit node of an OBSS) so that these potential channel re-users may decide if they can reuse the channel during the data transmission between the STA 104 and the AP 102. Assuming the RTS/CTS frames (or other transmission request/permission messages) are correctly decoded, the starting data transmission from the STA 104 to the AP 102 is guaranteed to take place, while another, simultaneous transmission in another BSS 110 or 120 by a node (an AP or a STA) will only take place conditionally by respecting the indicated maximum tolerable interference level at the receiver node AP 102. In case the data transmission from the STA 104 to the AP 102 does not take place, then a potential transmit node (e.g. the AP 112 or the STA 114) of the overlapping BSS 110 may be free to use or contend for the channel.

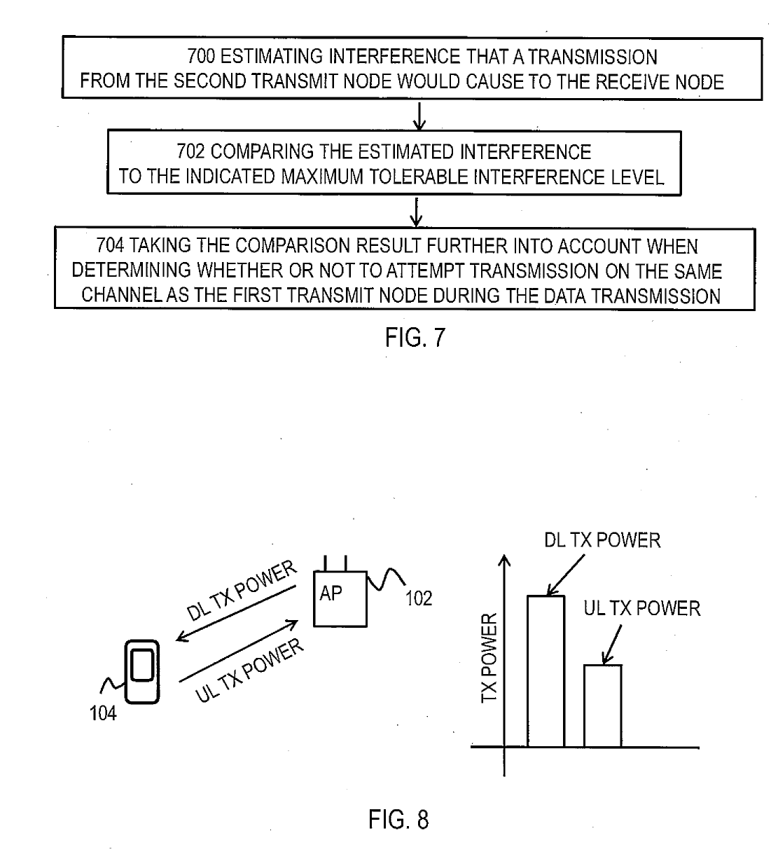

Furthermore, in an embodiment as shown in FIG. 8, there are different DL and UL transmit powers. When the transmit powers of the AP 102 and the STA 104 are unbalanced, e.g. the AP transmit power is higher than that of the STA 104, the performance of the system may be further degraded. Such a scenario may be common in outdoor Wi-Fi deployments, where the transmit power of the AP 102 may be higher than the transmit power of the STA 104. Then, the UL transmission coverage is smaller than the DL transmission coverage. This may lead to situations in which an UL transmission in the first BSS 100 may not be heard by the nodes in the second BSS 110. However, as described earlier, the proposed solution may provide for a coordinated channel re-use in both cases: when the UL transmission is heard by a node in the other BSS 110 (an exposed node -problem) or when the UL transmission is not heard by the node in the other BSS 110 (a hidden node problem). Therefore, the proposed signalling mechanism and the transmission request/permission messages may implement a decentralized coordination of OBSS 110 transmissions also in deployments comprising unbalanced DL/UL transmit powers.

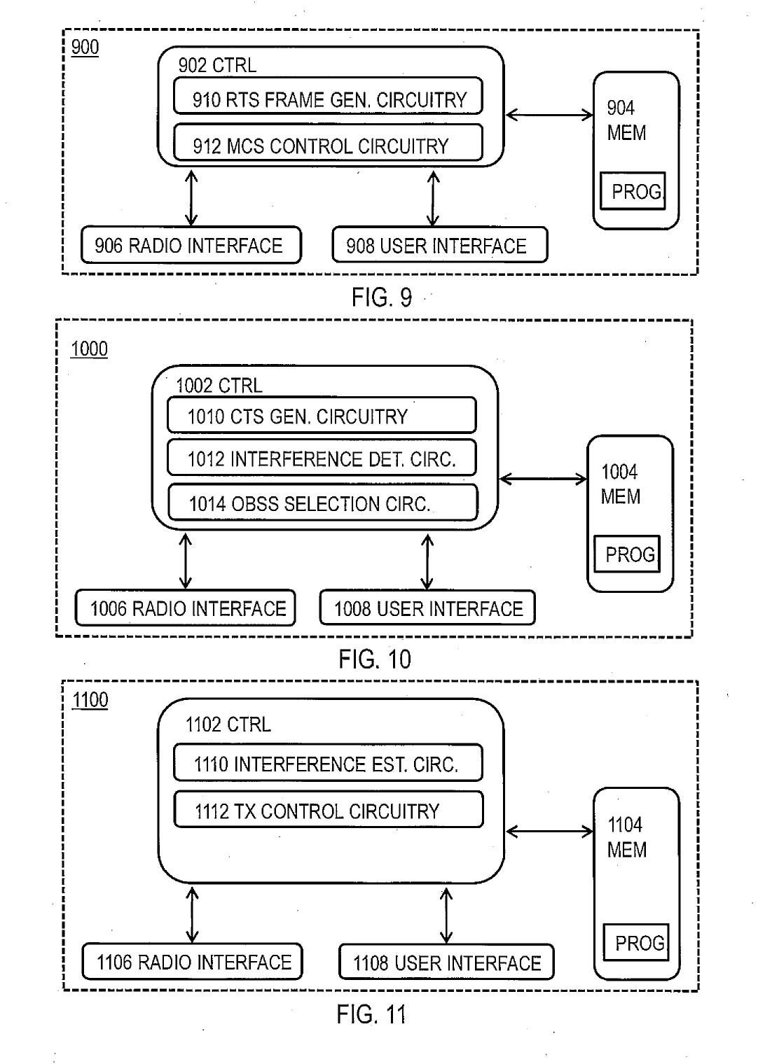

FIGS. 9 to 11 provide apparatuses 900, 1000, and 1100 com-prising a control circuitry (CTRL) 902, 1002, 1102, such as at least one processor, and at least one memory 904, 1004, 1104 including a computer pro-gram code (PROG), wherein the at least one memory and the computer pro-gram code (PROG), are configured, with the at least one processor, to cause the respective apparatus 900, 1000, 1100 to carry out any one of the embodiments described. The memories may be implemented using any suitable data storage technology, such as semiconductor based memory devices, flash memory, magnetic memory devices and systems, optical memory devices and systems, fixed memory and removable memory.

The apparatuses 900, 1000, 1100 may further comprise communication interfaces (TRX) 906, 1006, 1106 comprising hardware and/or software for realizing communication connectivity according to one or more communication protocols. The TRX may provide the apparatus with communication capabilities to access the radio access network, for example.

The apparatuses 900, 1000, 1100 may also comprise user inter-faces 908, 1008, 1108 comprising, for example, at least one keypad, a microphone, a touch display, a display, a speaker, etc. Each user interface may be used to control the respective apparatus by the user.

In an embodiment, the apparatus 900 may be or be comprised in a terminal device, e.g. a user equipment (UE), a user terminal (UT), a computer (PC), a laptop, a tabloid computer, a cellular phone, a mobile phone, a communicator, a smart phone, a palm computer, or any other communication apparatus. Further, the apparatus 1200 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 900 may be, comprise or be comprised in the STA 104 operating according to the wireless local area network of the IEEE 802.11.

The control circuitry 902 may comprise a group RTS frame generation circuitry 910 for generating the transmission request message, such as the RTS frame), according to any of the embodiments. A modulation and coding scheme circuitry 912 may be e.g., for determining which MCS to use for the transmission request message and for the data transmission related to the transmission request message.

In an embodiment, the apparatus 1000 may be or be comprised in a wireless access node/point of wireless local area network. In an embodiment, the apparatus 1000 may be, comprise or be comprised in the AP 102 operating according to the wireless local area network of the IEEE 802.11.

The control circuitry 1002 may comprise a CTS generation circuitry 1010 for generating the transmission permission message, such as the CTS frame, according to any of the embodiments. The control circuitry 1002 may further comprise an interference determination circuitry 1012 for determining the maximum tolerable interference level accepted, according to any of the embodiments. An overlapping BSS (OBSS) selection circuitry 1014 may be for selecting the overlapping BSS which is allowed to re-use the channel during the data transmission from the STA 104 to the AP 102, for example.

In an embodiment, the apparatus 1100 may be or be comprised in a terminal device, e.g. a user equipment (UE), a user terminal (UT), a computer (PC), a laptop, a tabloid computer, a cellular phone, a mobile phone, a communicator, a smart phone, a palm computer, or any other communication apparatus. Further, the apparatus 1200 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In another embodiment, the apparatus 1100 may be or be comprised in a wireless access node/point of wireless local area network.

In an embodiment, the apparatus 1100 may be, comprise or be comprised in a STA of an overlapping BSS 110/120 operating according to the wireless local area network of the IEEE 802.11. In an embodiment, the apparatus 1100 may be, comprise or be comprised in an AP of an overlapping BSS 110/120 operating according to the wireless local area network of the IEEE 802.11.

The control circuitry 1102 may comprise an interference estimation circuitry 1110 for estimating the amount of interference caused to the receive node of other BSS 100, according to any of the embodiments. A transmission control circuitry 1112 may be for deciding whether or not to attempt data transmission on the same channel as is being used in the first BSS 100.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus paratus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(sysoftware including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server; a cellular network device, or another network device.

In an embodiment, at least some of the processes described in connection with FIGS. 1 to 11 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rear-ranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 11 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. Method, comprising:
receiving, by a receive node, a transmission request message for data transmission from a transmit node of a first basic service set, wherein the transmission request message comprises an indication of a modulation and coding scheme to-be-used in the data transmission;
detecting signal strength of the transmission request message;
determining, based on the signal strength and the indicated modulation and coding scheme, a maximum tolerable interference level during the data transmission; and
in response to the transmission request message, generating and sending, to the transmit node, a transmission permission message comprising an indication of the maximum tolerable interference level.

2. The method of claim 1, wherein the modulation and coding scheme to-be-used in the data transmission is different than the modulation and coding scheme used in the transmission request message.

3. The method of claim 1, further comprising: including an indication of a transmit power of the receive node in the transmission permission message.

4. The method of claim 1, further comprising:
determining which overlapping basic service set is allowed to reuse the same channel as the transmit node during the data transmission; and
including, to the transmission permission message, an indication of the overlapping basic service set, which is allowed to reuse the same channel as the transmit node during the data transmission.

5. The method of claim 1, wherein the transmission request message is a request-to-send-message and the transmission permission message is a clear-to-send-message.

6. Method, comprising:
detecting, by a second transmit node of a second basic service set, a transmission permission message transmitted from a receive node of a first basic service set to a first transmit node of the first basic service set, wherein the transmission permission message indicates an upcoming data transmission from the first transmit node to the receive node;
acquiring, based on the transmission permission message, an indication of a basic service set, which is allowed to reuse the same channel as the first transmit node during the data transmission;
determining, based on the indication, whether the second basic service set is allowed to reuse the same channel as the first transmit node during the data transmission; and
as a response to the determination result, deciding whether or not to attempt transmission on same channel as the first transmit node during the data transmission.

7. The method of claim 6, wherein the transmission permission message further comprises an indication of a maximum tolerable interference level at the receive node during the upcoming data transmission, the method further comprising:
estimating interference that a transmission from the second transmit node would cause to the receive node;
comparing the estimated interference to the indicated maximum tolerable interference level; and
taking the comparison result further into account when determining whether or not to attempt transmission on the same channel as the first transmit node during the data transmission.

8. The method of claim 7, further comprising:
detecting signal strength of the transmission permission message;
determining, based on the detected signal strength, path loss between the receive node and the second transmit node; and
estimating the interference that a transmission from the second transmit node d would cause to the receive node on the basis of the path loss.

9. The method of claim 8, wherein the transmission permission message further comprises an indication of a transmit power of the receive node, and the transmit power of the receive node is otherwise unknown, the method further comprising:
taking the indicated transmit power of the receive node further into account when determining the path loss between the receive node and the second transmit node.

10. An apparatus, comprising:
at least one processor and at least one memory including a computer program code, wherein the at least one memory and the computer program code are configured, with the at least one processor, to cause a receive node to perform operations comprising:
receiving a transmission request message for data transmission from a transmit node of a first basic service set, wherein the transmission request message comprises an indication of a modulation and coding scheme to-be-used in the data transmission;
detecting signal strength of the transmission request message;
determining, based on the signal strength and the indicated modulation and coding scheme, a maximum tolerable interference level during the data transmission; and
in response to the transmission request message, generating and sending, to the transmit node, a transmission permission message comprising an indication of the maximum tolerable interference level.

11. The apparatus of claim 10, wherein the modulation and coding scheme . to-be-used in the data transmission is different than the modulation and coding scheme used in the transmission request message,

12. The apparatus of claim 10, wherein the at least one memory and the computer program code are configured, with the at least one processor, to cause the receive node to perform operations comprising:
including an indication of a transmit power of the receive node in the transmission permission message.

13. The apparatus of claim 10, wherein the at least one memory and the computer program code are configured, with the at least one processor, to cause the receive node to perform operations comprising:
determining which overlapping basic service set is allowed to reuse the same channel as the transmit node during the data transmission; and
including, to the transmission permission message, an indication of the overlapping basic service set, which is allowed to reuse the same channel as the transmit node during the data transmission.

14. The apparatus of claim 10, wherein the transmission request message is a request-to-send-message and the transmission permission message is a clear-to-send-message.

15. The apparatus of claim 10, wherein the transmit node is a user terminal operating according to the wireless local area network of the IEEE 802.11 and the receive node is an access point operating according the wireless local area network of the IEEE 802.11.

16. An apparatus, comprising:
at least one processor and at least one memory including a computer program code, wherein the at least one memory and the computer program code are configured, with the at least one processor, to cause a second transmit node of a second basic service set to perform operations comprising:
detecting a transmission permission message transmitted from a receive node of a first basic service set to a first transmit node of the first basic service set, wherein the transmission permission message indicates an upcoming data transmission from the first transmit node to the receive node;
acquiring, based on the transmission permission message, an indication of a basic service set, which is allowed to reuse the same channel as the first transmit node during the data transmission;
determining, based on the indication, whether the second basic service set is allowed to reuse the same channel as the first transmit node during the data transmission; and
as a response to the determination result, deciding whether or not to attempt transmission on same channel as the first transmit node during the data transmission.

17. The apparatus of claim 16, wherein the transmission permission message further comprises an indication of a maximum tolerable interference level at the receive node during the upcoming data transmission, and wherein the at least one memory and the computer program code are configured, with the at least one processor, to cause the second transmit node to perform operations comprising:
estimating interference that a transmission from the second transmit node would cause to the receive node;
comparing the estimated interference to the indicated maximum tolerable interference level; and
taking the comparison result further into account when determining whether or not to attempt transmission on the same channel as the first transmit node during the data transmission.

18. The apparatus of claim 17, wherein the at least one memory and the computer program code are configured, with the at least one processor, to cause the second transmit node to perform operations comprising:
detecting signal strength of the transmission permission message;
determining, based on the detected signal strength, path loss between the receive node and the second transmit node; and
estimating the interference that a transmission from the second transmit node would cause to the receive node on the basis of the path loss.

19. The apparatus of claim 18, wherein the transmission permission message further comprises an indication of an otherwise transmit power of the receive node, wherein the at least one memory and the computer program code are configured, with the at least one processor, to cause the second transmit node to perform operations comprising:
taking the indicated transmit power of the receive node further into account when determining the path loss between the receive node and the second transmit node.

20. The apparatus of claim 16, wherein the first transmit node is a user terminal operating according to the wireless local area network of the IEEE 802.11, the receive node is an access point operating according the wireless local area network of the IEEE 802.11, and the second transmit node is either a user terminal or an access point operating according the wireless local area network of the IEEE 802.11.

21. (canceled)

22. (canceled)

23. (canceled)

24. (canceled)
